(19) United States
(12) Patent Application Publication
(10) Pub. No.: US 2004/0064520 A1
(43) Pub. Date: Apr. 1, 2004

(54) Network identification information automatic management system and method

(75) Inventors: Naoki Takahashi, Zama-shi (JP); Takashi Inui, Yokohama-shi (JP); Masahiko Nomura, Sagamihara-shi (JP); Mizuho Tadokoro, Yamato-shi (JP)

Correspondence Address: IBM CORPORATION, PO BOX 12195, DEPT 9CCA, BLDG 002, RESEARCH TRIANGLE PARK, NC, 27709, US

(73) Assignee: International Business Machines Corporation, Armonk, NY

(21) Appl. No.: 10/453,430

(22) Filed: Jun. 3, 2003

(30) Foreign Application Priority Data
Jun. 3, 2002 (JP) 2002-161179

(51) Int. Cl. G06F 15/16

(52) U.S. Cl. 709/208; 709/220; 709/226

(57) ABSTRACT

A system and method to improve the dynamic management of network addresses is shown. A network including a DHCP server is enabled to allocate and reclaim network address assignments. The disclosed system includes a device driver program for controlling a computer that communicates with equipment on a network using terminal identification information acquired from a server and an operation halt program for performing a halting process for halting the operation of the computer. A determination program is also included for determining whether or not the halting process has been initiated by the operation halt program. When it is determined that the halting process has been initiated, a provided sending program sends information to the server that the use of the terminal identification information is terminated.

### BACKGROUND of the INVENTION

The invention relates to a program, a control device, and a control method. More particularly, the invention relates to a program, a control device, and a control method for dynamically acquiring an IP address from a DHCP server and communicating with equipment on a network using the IP address.

DHCP protocol has been traditionally used as a protocol for dynamically allocating IP addresses to terminals connected to a network. With DHCP protocol, a terminal that has been newly connected to a network requests a DHCP server to allocate an IP address to it.

However, prior art terminals do not notify the DHCP server when they terminate the use of the allocated IP address when the terminal stops its operation due to shutoff of power supply, suspension of utilization and the like. This can delay the release of IP addresses managed by the DHCP server and cause the shortage of IP addresses available in the network.

Thus, it is a purpose of the invention to provide an information processing apparatus and a control method in which the above-mentioned problems are solved. This purpose is accomplished by a combination of features as defined in independent claims in the scope of claims. Also, the dependent terms define preferable examples of the invention.

### SUMMARY OF THE INVENTION

According to a first embodiment of the invention, the invention provides: a program for controlling a computer that communicates with equipment on a network using terminal identification information acquired from a server, comprising operation halt means for performing a halting process of halting the operation of the computer, determination means for determining whether or not the halting process has been initiated by the operation halt means, and sending means for sending information that the use of the terminal identification information is terminated to the server if it is determined that the halting process has been initiated; a recording medium having the program recorded thereon; a control device operating in accordance with the program; and a control method for controlling the device.

According to a second embodiment of the invention, the invention provides: a program for controlling a computer that communicates with equipment on a network using terminal identification information acquired from a server, comprising communication halt means for performing a communication halting process for reducing power consumption of the computer by bringing the computer into a communication halt state in which external communication is disabled, determination means for determining whether or not the communication halting process has been initiated by the communication halt means, and sending means for sending information that the use of the terminal identification information is terminated to the server if it is determined that the communication halting process has been initiated; a recording medium having the program recorded thereon; a control device operating in accordance with the program; and a control method for controlling the device.

According to a third embodiment of the invention, the invention provides: a program for controlling a computer that communicates with equipment on a network using terminal identification information acquired from a server, comprising communication halt determination means for determining whether or not a communication application program that uses the communication interface portion or controller of the computer is operating, and sending means for sending information that the use of the terminal identification information is terminated to the server if it is determined that the communication application program is not operating; a recording medium having the program recorded thereon; a control device operating in accordance with the program; and a control method for controlling the device.

According to a fourth embodiment of the invention, the invention provides: a program for controlling a computer that comprises means for shifting or setting the computer to a halt state in which an operating system is halted with the execution state of the operating system preserved and that communicates with equipment on a network using terminal identification information acquired from a server, comprising recovery means for recovering from the halt state in response to external directions, and terminal identification information validation means for querying the server whether or not pre-halt terminal identification information that was used just before the halt state can be reused for communication with the equipment on a network when the computer has recovered from the halt state; a recording medium having the program recorded thereon; a control device operating in accordance with the program; and a control method for controlling the device.

The above summary of the invention does not enumerate all of the necessary features for the present invention, but some combinations of these features may also be inventive features.

### BRIEF DESCRIPTION OF THE DRAWINGS

Some of the purposes of the invention having been stated, others will appear as the description proceeds, when taken in connection with the accompanying drawings, in which:

FIG. 1 generally illustrates devices that communicate using an automatic terminal identification information granting system 10;

FIG. 2 is a functional block diagram of a control device 40;

FIG. 3 is a flow chart of the operation of a DHCP server 20 and the control device 40;

FIG. 4 is a flow chart showing detailed operations at S450 in FIG. 3;

FIG. 5 is a functional block diagram of the control device 40 in a modified embodiment;

FIG. 6 is a flow chart of the DHCP server 20 and the control device 40 in the modified embodiment; and

FIG. 7 shows an example of the hardware configuration of the control device 40.

### DETAILED DESCRIPTION OF THE ILLUSTRATIVE EMBODIMENTS

While the present invention will be described more fully hereinafter with reference to the accompanying drawings, in which the preferred embodiments of the present invention are shown, it is to be understood at the outset of the description which follows that persons of skill in the appropriate arts may modify the invention here described while still achieving the favorable results of this invention. These embodiments are not intended to limit the invention, the scope of which is determined by the Claims, and all combinations of the features described in the embodiments are not necessarily fundamental for the solution of the invention.

Accordingly, the description which follows is to be understood as being a broad, teaching disclosure directed to persons of skill in the appropriate arts, and not as limiting upon the present invention.

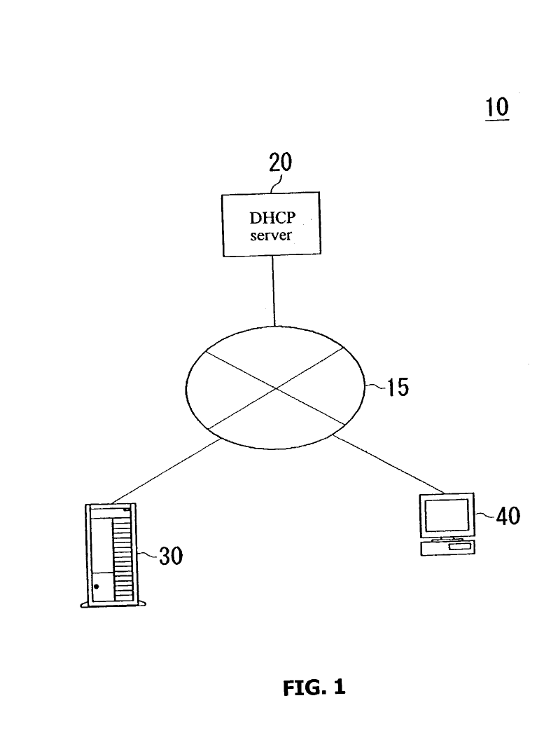

Referring now more particularly to the accompanying drawings, FIG. 1 generally illustrates an automatic terminal identification information granting system 10. The terminal identification information automatically granting system 10 comprises a DHCP server 20, a control device 40, and a terminal 30. The DHCP server 20, terminal 30, and control device 40 communicate with one another via a network 15. The control device 40 is just an example of computers according to the invention. The computer alternatively may be a portable notebook terminal or a mobile terminal that is capable of wireless communication and the network 15 may include a wireless network.

On initiating its operation in response to a direction to start up and the like, the control device 40 obtains an IP address, which is terminal identification information used for communication with other equipment (e.g. the terminal 30) on the network 15, from the DHCP server 20 and initiates communication with the terminal 30. Subsequently, the DHCP server 20 will manage the IP address as associated with the control device 40 until it explicitly receives information from the control device 40 that the unit 40 has terminated the use of the IP address, or until a predetermined time period has passed since the control device 40 started to use the IP address.

The control device 40 shifts to the halt state in which the operation of the operating system is suspended when the user temporarily stops using the unit. In this embodiment, the control device 40 sends information that it has stopped using the IP address to the DHCP server 20 when it shifts to the halt state. In addition, the control device 40 reacquires and reuses the IP address as necessary when it recovers from the halt state. The DHCP server 20 accordingly can receive the IP address utilization information from the control device 40 whenever the situation changes, which allows the server 20 to manage the assignment and release of IP addresses correctly.

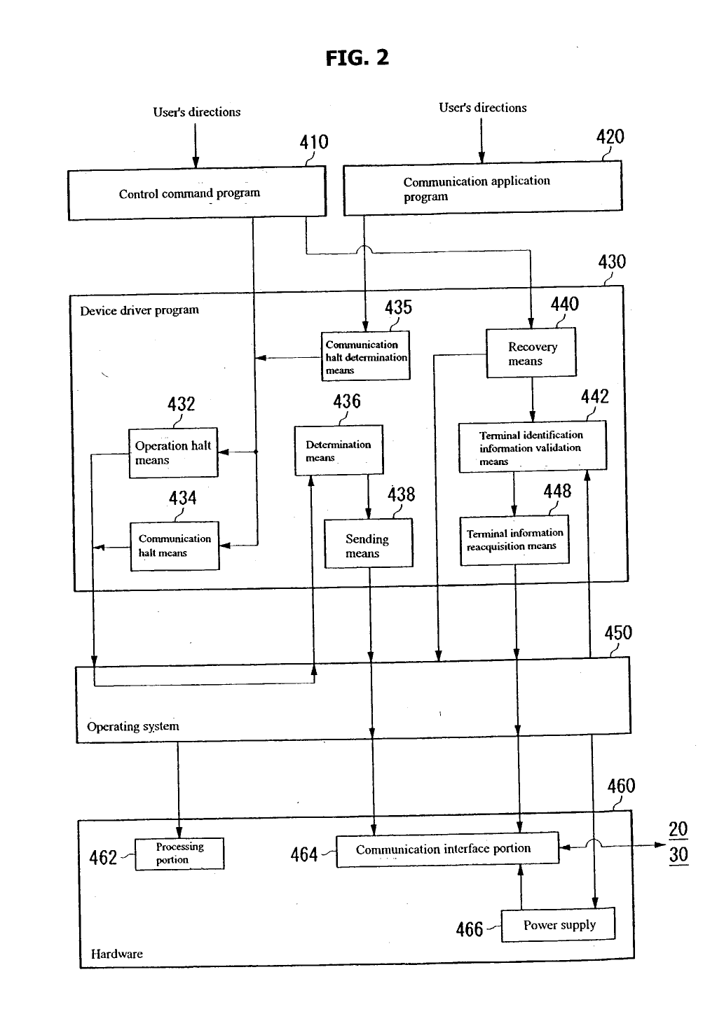

FIG. 2 illustrates a functional block diagram of the control device 40. The control device 40 comprises a control command program 410, communication application program 420, device driver program 430, operating system 450, and hardware 460. The control command program 410 is a program that provides a user with ability to set operation status of the operating system or to set power supply and operation halt for a portion or the entire control device 40, commonly provided to users packaged with an operating system and the like. The communication application program 420 is a program for providing a user with communication interface, such as an Internet browser, e-mail software, and group ware.

The control command program 410 may initiate a halting process to stop the control device 40's operation by sending external directions (e.g. the user's directions) to the device driver program 430. For example, as the halting process proceeds, the device driver program 430 causes the control device to go into the halt state in which the operating system is suspended, preserving the execution state of the operating system that manages the control device 40. The communication application program 420 periodically sends its operation status (e.g. information indicating whether it is communicating or not) to the device driver program 430.

The device driver program 430 causes the operating system 450 to perform the halting process, in accordance with the directions received from the control command program 410. The device driver program 430 also causes the operating system 450 to perform the halting process based on the operation status information received from the communication application program 420. Complying with the directions received from the device driver program 430, the operating system 450 initiates the halting process and sends information indicating the commencement of the halting process back to the device driver program 430. Upon receiving the information about the commencement of the halting process from the operating system 450, the device driver program 430 causes the hardware 460 to send information to the DHCP server 20 indicating that the control device 40 has stopped using the IP address.

Meanwhile, when it receives the appropriate user's direction while in the halt state, the control device 40 returns to the operating state. In returning to its operating state, the hardware 460 first starts to supply power to the hardware 460 if necessary. The control command program 410 then starts the process of bringing the control device 40 back to its operating state by sending the user's direction to the device driver program 430. The device driver program 430 causes the operating system 450 to start to operate in accordance with the direction received from the control command program 410. The device driver program 430 then determines if the pre-halt IP address, that is the terminal identification information used before initiating the halting process, can be reused or not, and, if necessary, again obtains an IP address from the DHCP server 20.

The device driver program 430 comprises operation halt means 432, communication halt means 434, communication halt determination means 435, determination means 436, sending means 438, recovery means 440, terminal identification information validation means 442, and terminal information reacquisition means 448.

When it receives a direction to initiate the halting process from the control command program 410, the operation halt means 432 causes the operating system 450 to start the halting process. For example, as the halting process proceeds the operation halt means 432 suspends the generation of the is operation clock performed internally in a processing portion or controller 462 in the process. As the halting process proceeds, the operation halt means 432 may also shift the control device 40 into an intermitted state (e.g. a state referred to as a suspend state), which is a halt state where the processing portion 462 stops communication processing, by storing the execution state of the operating system in memory. The operation halt means 432 may also shift the control device 40 to a sleep state (e.g. a state known as a hibernation state), which is an example of halt states, by storing the execution state of the operating system in a non-volatile recording medium. The operation halt means 432 may also bring the control device 40 into a power-off state (e.g. a state known as a shutdown state) in which power supply to the control device 40 is shut off as the halting process.

Upon receiving a direction from the control command program 410 to bring the control device 40 into a communication halt state in which external communication is disabled, the communication halt means 434 causes the operating system 450 to start communication processing for shifting the control device to the communication halt state. The communication halt determination means 435 determines if the communication application program 420 is operating or not by analyzing the operation status of the communication application program 420, and causes the communication halt means 434 to perform the communication halting process if necessary. In the communication halting process, the communication halt means 434 may cause the power supply 466 to stop supplying power to the communication interface portion or controller 464 via the operating system 450, for example. When it receives information that the halting process or communication halting process has been initiated from the operating system 450, the determination means 436 sends a direction to stop using the IP address to the sending means 438. In response, the sending means 438 sends information that the use of the IP address will be terminated to the DHCP server 20 via the operating system 450 and the communication interface portion 464.

Meanwhile, when it receives a direction to bring the control device 40 back to its operating state from the user via the control command program 410 in the halt state, the recovery means 440 so informs the terminal identification information validation means 442 and the operating system 450. The recovery means 440 will recover from the halt state when the user presses a power switch or a predetermined key, as examples of external directions to return to the operating state. Alternatively, the recovery means 440 may decide that it has received a direction from the user and recover from the halt state when the control device 40 receives a predefined signal via the network 15 or receives a predefined signal via the modem provided on the control device 40. The recovery means 440 may also recover from the halt state at a time which has been set in advance by the user using the control command program 410 or after a predetermined time period has passed since a time point set by the user.

The terminal identification information validation means 442 causes the operating system 450 and the communication interface 464 to check if the pre-halt IP address that was used before entering the halt state can be reused or not, and sends the result to the terminal information reacquisition means 448. For example, the control device 40 uses the operating system 450 and the communication interface portion 464 to query the DHCP server 20 if it can use the IP address again or not. If the pre-halt identification information cannot be reused, the terminal information reacquisition means 448 causes the operating system 450 and the communication interface portion 464 to obtain an IP address again.

Thus, the control device 40 sends information that it stops using an IP address is to the DHCP server 20 when it halts its operation, and checks if the IP address can be used again or not using the DHCP server 20 when it recovers from a state in which it stops its operation. The control device 40 therefore can communicate the utilization of an IP address to the DHCP server 20 properly.

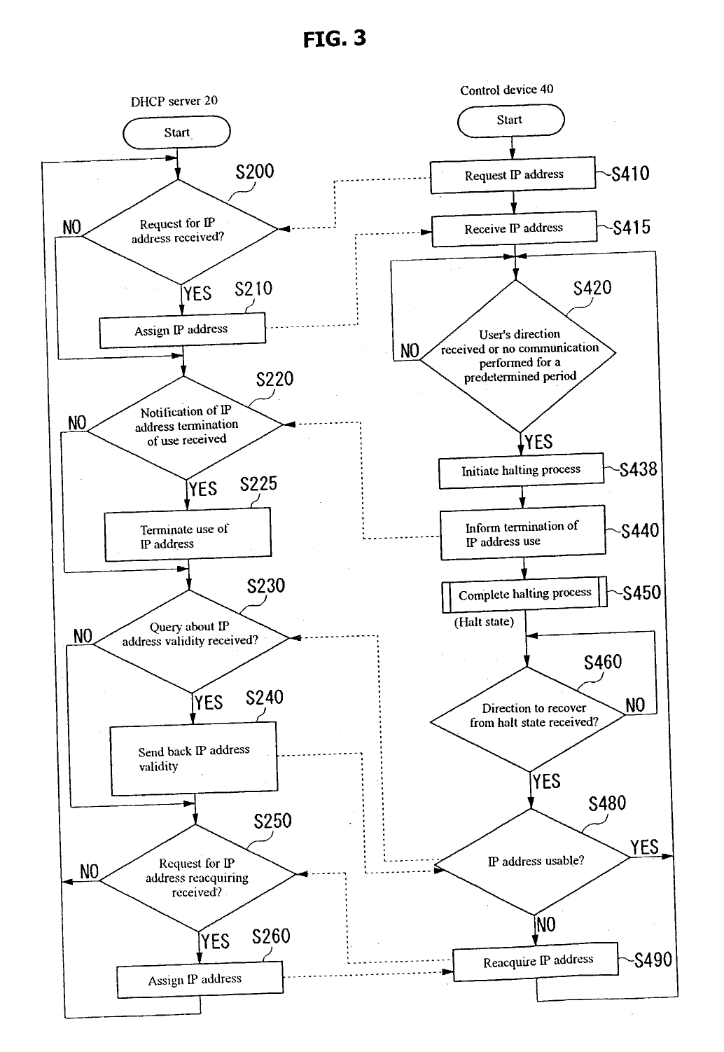

FIG. 3 shows a flow chart of the operation of the DHCP server 20 and the control device 40. When initiating its operation in response to startup and the like, the control device 40 sends a request for assigning it an IP address to the DHCP server 20. If it determines that it received a request for assigning an IP address (S200:YES), the DHCP server 20 assigns an IP address to the control device 40 (S210). The control device 40 receives the assigned IP address (S415) and initiates communication using the IP address.

The operation halt means 432, communication halt means 434, and communication halt determination means 435 perform the following operations periodically. The communication halt determination means 435 determines whether the communication application program 420 is operating or not by analyzing the operation status of the communication application program 420. The operation halt means 432 or the communication halt means 434 initiates halting process (S438) if it receives a direction to start the halting process from the user (S420). On the other hand, the communication halt determination means 435 starts the halting process (S438) if communication by way of the communication application program 420 has not been performed for a predetermined period (S420).

As the halting process, the operation halt means 432 first sends a notification that the use of the IP address will be terminated to the DHCP server 20 (S440) and completes the halting process (S450). If it receives the notification that the control unit 40 stops using the IP address from the control device 40 (S220:YES), the DHCP server 20 manages the IP address as an unused one for assigning to other devices (S225).

If the control device 40 determines that it received a direction to recover from the halt state by receiving an input to a predetermined key or a switch by the user (S460:YES), the terminal identification information validation means 442 checks to see whether the pre-halt IP address can be used again or not (S480). As another example of directions to recover from the halt state, the control device 40 may decide that a direction to recover from the halt state has been received if a time period preset by the user has elapsed, for example. In validation, the terminal identification information validation means 442 makes an inquiry to the DHCP server 20 if the pre-halt IP address can be reused or not using the operating system 450 and the like, for example. If it receives an inquiry asking if the IP address can be used again or not (S230:YES), the DHCP server 20 checks if the IP address can be still used or not and sends the result back to the control device 40 (S240). If it has been determined that the pre-halt IP address can be reused (S480:YES), the control device 40 returns to S420. If it has not been determined that the pre-halt IP address can be reused (S480:NO), the terminal information reacquisition means 448 sends a request for reacquiring an IP address to the DHCP server 20 (S490). If it receives a request for reacquiring an IP address again (S250:YES), the DHCP server 20 assigns an IP address and sends the IP address to the control device 40 (S260). The control device 40 uses the obtained IP address to resume communication and returns to S420.

In such a way, the control device 40 can allow the DHCP server 20 to manage IP addresses properly by sending a notification that use of an IP address will be terminated and a request for reacquiring an IP address to the DHCP server 20.

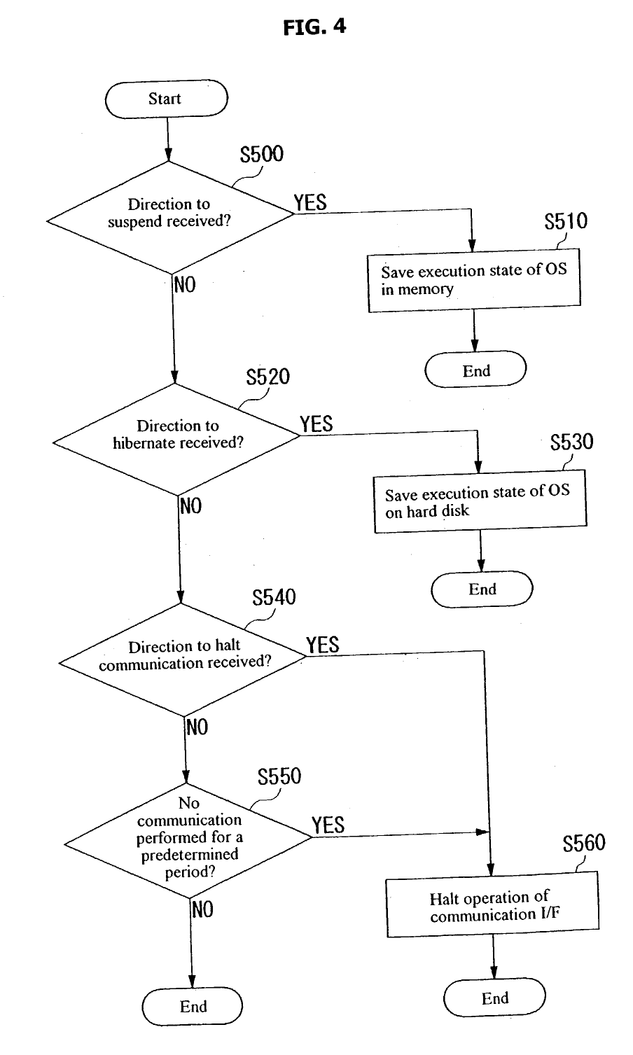

FIG. 4 shows a flow chart illustrating detailed operations at S450 in FIG. 3. If it receives a direction to suspend from the control command program 410 (S500:YES), the operation halt means 432 preserves the execution state of the operating system (OS) in memory (S510). Then, if it receives a direction to hibernate from the control command program 410 (S520:YES), the operation halt means 432 preserves the execution state of the operating system in a hard disk, which is a non-volatile recording medium (S530). Then, if the operation halt means 434 receives a direction to halt communication from the control command program 410 (S540:YES), or if it is determined that communication through the communication application program 420 using the hardware 460 has not been performed for a predetermined time (S550:YES), the communication halt means 434 performs communication halting process for reducing power consumption of the control device 40 by stopping the operation of the communication interface portion 464 (S560) so as to bring the control device 40 into a communication halt state in which external communication is disabled.

The control device 40 thus can stop the operations for communication and the like of the control device 40 based on user's directions or detection of communication status of an application program.

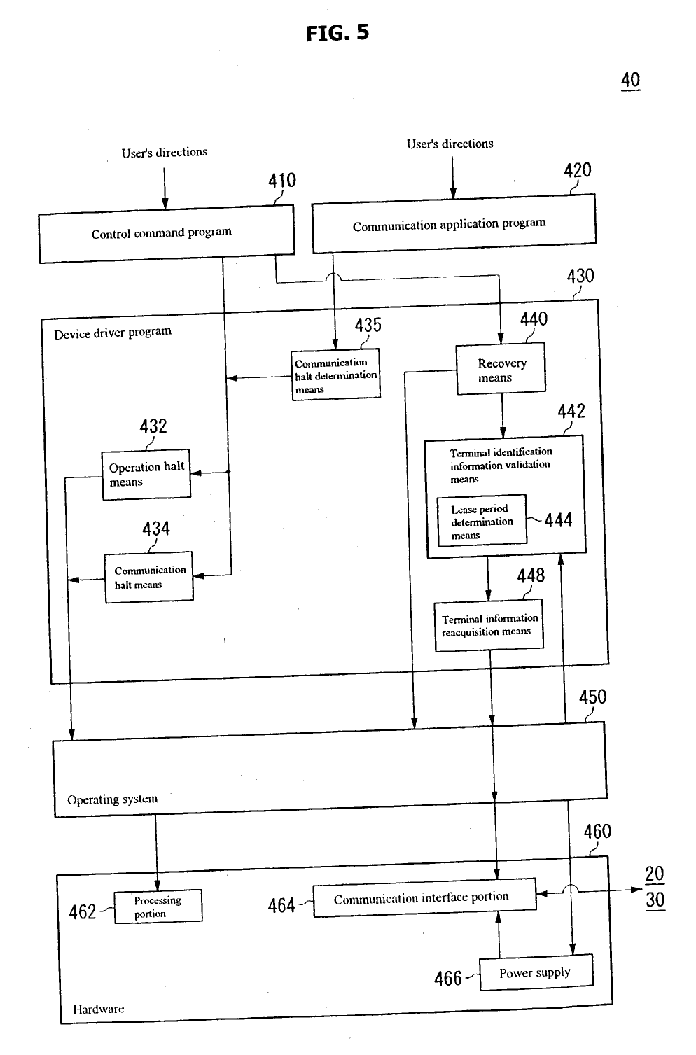

FIG. 5 shows a functional block diagram of the control device 40 in the modification of the embodiment. Since the control command program 410, communication application program 420, operation halt means 432, communication halt means 434, communication halt determination means 435, recovery means 440, terminal identification information validation means 442, terminal information reacquisition means 448, operating system 450, and hardware 460 in FIG. 5 have almost similar configurations to those of the members indicated by the same reference numbers in FIG. 2, description about them is omitted. In this modification, the terminal identification information validation means 442 has lease period determination means 444. In contrast to the control device 40 in FIG. 2, the control device 40 in this modification completes the halting process without notifying the DHCP server 20 that it terminates the use of an IP address when the operation halt means 432 and the communication halt means 434 have started the halting process. And when the control device 40 is returning to the operating state, the terminal identification information validation means 442 uses the lease period determination means 444 to decide if the pre-halt IP address can be reused. For example, when the control device 40 acquires an IP address, the lease period determination means 444 gets the time of the acquisition and the validity period of the IP address from the operating system 450 beforehand and manages them. And when it receives a direction to return the control device 40 to its operating state from the recovery means 440, the terminal identification information validation means 442 determines whether or not a predetermined time period (e.g. the validity period of the IP address managed by the lease period determination means 444) has passed since the control device started to use the pre-halt IP address that had been used before initiating the halting process by way of the lease period determination means 444. Then, based on the determination, the terminal identification information validation means 442 determines if it should query the DHCP server 20 to determine if the pre-halt IP address can be reused.

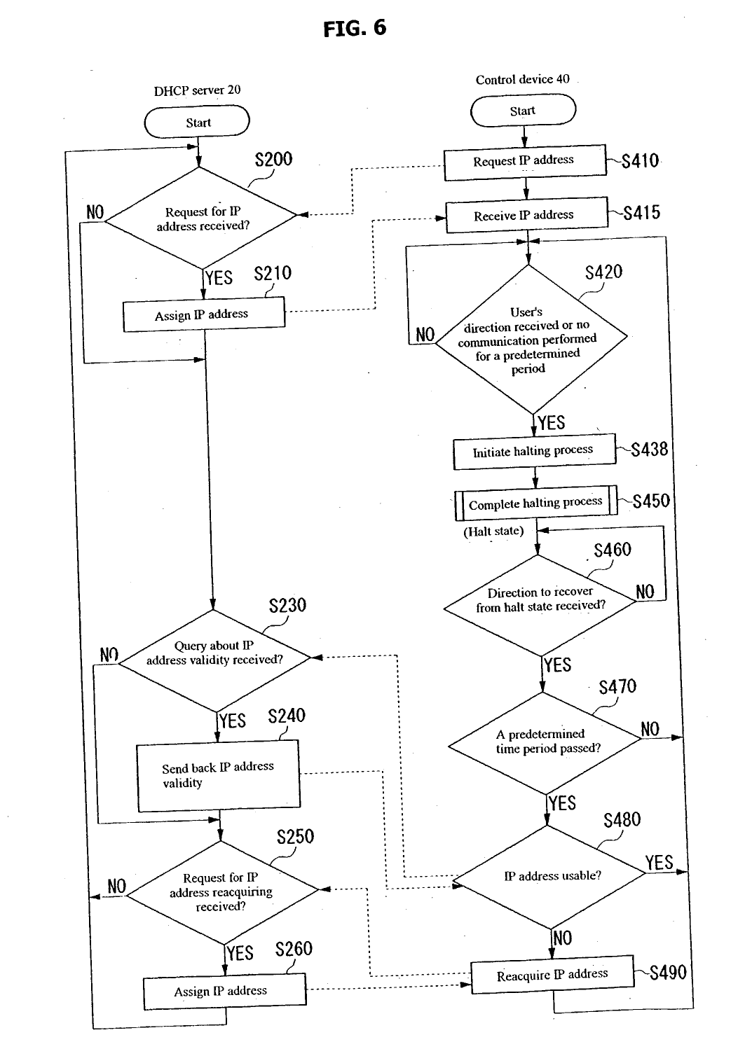

FIG. 6 shows a flow chart of operations of the DHCP server 20 and the control device 40 in this modified embodiment. Since the operations of the control device 40 differ only in part from those shown in the flow chart in FIG. 3, only the differences will be described. In this modification, the control device 40 does not inform the DHCP server 20 that it terminates the use of an IP address if the halting process has been initiated (S438). The control device 40 then completes the halting process (S450).

If the control device 40 receives a direction to recover from the halt state from the user (S460:YES), the lease period determination means 444 determines if a predetermined time period has passed since it started to use the pre-halt IP address which was used before entering the halt state (S470). The control device 40 may record the time at which the pre-halt IP address is obtained and its validity period in advance at the point the pre-halt IP address is obtained, for example. The lease period determination means 444 then determines if the current time is within the validity period or not to decide the elapse of the predetermined time period.

If it is determined that a predetermined time period has not passed since it started to use the pre-halt IP address (S470:NO), the control device 40 reuses the pre-halt IP address to initiate communication and returns to S420. If it is determined that a predetermined time period has passed since it started to use the pre-halt IP address (S470:YES), the control device 40 proceeds to S480 and subsequently performs processes similar to those shown in FIG. 3.

The control device 40 thus does not inform the DHCP server 20 that it terminates the use of an IP address in this modification. The control device 40 can determine if a pre-halt IP address can be reused or not without querying the DHCP server 20 when it recovers from the halt state, and can query the DHCP server 20 only when it is determined that the pre-halt IP address is not reusable.

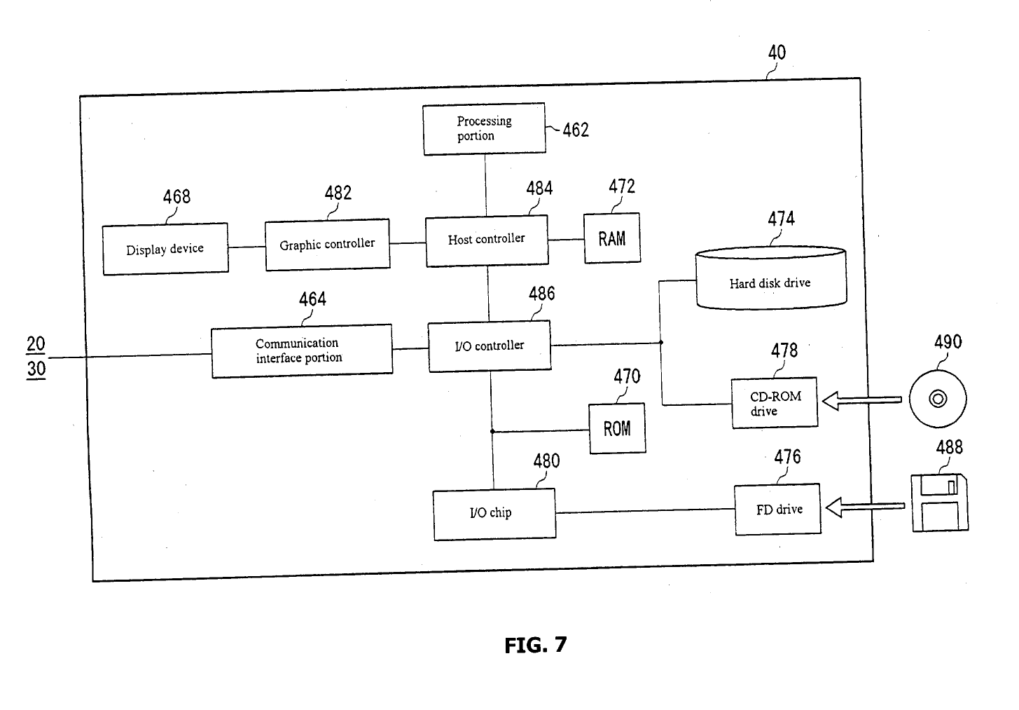

FIG. 7 illustrates an example of the hardware configuration of the control device 40. The control device 40 comprises a CPU peripheral portion having a processing portion 462, RAM 472, graphic controller 482, and display device 468 that are interconnected by a host controller 484, an input/output portion having a communication interface portion 464, hard disk drive 474, and CD-ROM drive 478 that are connected to the host controller 484 via an input/output controller 486, and a legacy input/output portion having ROM 470, a floppy disk drive 476, and input/output chip 480 that are connected to the input/output controller 486.

The host controller 484 connects the RAM 472 with the processing portion or controller 462 and the graphic controller 482 that access the RAM 472 at a high transfer rate. The processing portion 462 operates according to a program stored in the ROM 470 and RAM 472 to control various portions. The graphic controller 482 obtains image data generated by the processing portion 462 and the like into a frame buffer provided in the RAM 472 and displays it on the display device 468. Alternatively, the graphic controller 482 may internally include a frame buffer for storing image data generated by the processing portion 462 and the like.

The I/O controller 486 connects the host controller 484, the communication interface portion 464 as a relatively high-speed I/O device, hard disk drive 474, and CD-ROM drive 478. The communication interface portion 464 communicates with other devices via a network. The hard disk drive 474 stores programs and data used by the control device 40. The CD-ROM drive 478 reads programs or data from the CD-ROM 490 and provides it to the I/O chip 480 via the RAM 472.

Also connected to the I/O controller 486 are the ROM 470 and a relatively low-speed I/O device such as the floppy disk drive 476 and I/O chip 480. The ROM 470 stores a boot program executed by the processing portion 462 during start-up time of the control device 40 and programs dependent on the hardware of the control device 40. The floppy disk drive 476 reads programs or data from a floppy disk 488 and provides it to the I/O chip 480 via the RAM 472. The I/O chip 480 connects the floppy disk 488, and various types of I/O devices via, for example, a parallel port, serial port, keyboard port, and mouse port. The I/O chip 480 also receives data corresponding to entry by a user from an input device and provides it to a program being executed on the control device 40.

Programs for realizing the control device 40 comprise a device driver program having a operation halt module, communication halt module, communication halt determination module, determination module, sending module, recovery module, terminal identification information validation module, and terminal information reacquisition module; an operating system; a control command program; and a communication application program. These modules are programs that allow the control device 40 to operate as the operation halt means 432, communication halt means 434, communication halt determination means 435, determination means 436, sending means 438, recovery means 440, terminal identification information validation means 442, terminal information reacquisition means 448, operating system 450, control command program 410, and communication application program 420.

The device driver program 430 provided to the control device 40 is supplied by a user as stored on a recording medium such as the floppy disk 488, CD-ROM 490, or an IC card and the like. The device driver program 430 is read out from the recording medium and installed on the control device 40 via the I/O chip 480, to be executed on the control device 40.

The programs and module may be stored on an external storage medium. Such storage media include an optical recording medium such as DVD and PD, a magneto-optical recording medium such as MD and the like, a tape medium, and semiconductor memory like an IC card, in addition to the floppy disk 488 and CD-ROM 490. A storage unit such as a hard disk and RAM provided on a server system connected to a dedicated communication network or the Internet may be used as such a recording medium so that programs are provided to the control device 40 over a network.

As can be seen from the embodiments above, the control device 40 can prevent shortage or overlapping use of IP addresses in the terminal identification information automatically granting system 10 by properly informing the DHCP server 20 whether the control device 40 is using an IP address or not.

According to the embodiments described above, the program, control device, and control method set forth in each of the following items are realized.

In the drawings and specifications there has been set forth a preferred embodiment of the invention and, although specific terms are used, the description thus given uses terminology in a generic and descriptive sense only and not for purposes of limitation.

While the present invention has been described with respect to the embodiment of the invention, the technical scope of the present invention is not limited to the described embodiment. Various changes and modifications may be made in the described embodiment. As is apparent from the description in the appended Claims, modes of the present invention characterized by such changes and modifications are also included in the technical scope of the invention.

We claim as our invention:

1) A program product comprising:
a computer usable medium having computer readable program code embodied therein for use with a computer that communicates with equipment on a network using a terminal identification information acquired from a server, the computer readable program code in said program product implementing functions effective to:
halt the operation of the computer;
determine whether said halt function of the computer has been initiated; and
send the server a message that the use of the terminal identification information is terminated when it has been determined said halt process has been initiated on the computer.

2) The program product according to claim 1, wherein said halt function places the computer in a halt state wherein the operation of an operating system that manages the computer is terminated with an execution state of the operating system preserved during said halt function.

3) The program product according to claim 2, wherein said halt function preserves the execution state of the operating system in memory provided on the computer and terminates communication with the network.

4) The program product according to claim 2, wherein said halt function preserves the execution state of the operating system in a non-volatile recording unit provided on the computer and terminates communication with the network.

5) The program product according to claim 2, further comprising functions effective to:
recover operation of the computer from the halt state in response to external directions; and
query the server whether the pre-halt state terminal identification information can be reused for network communications upon resumption of full operation.

6) The program product according to claim 1, wherein the terminal identification information is an IP address and the server is a DHCP server.

7) The program product according to claim 1, wherein said halt function sends information to an operating system to signal that termination will be performed, and said determine function is a device driver that decides whether said halt function has been initiated based on information received from the operating system.

8) A program product comprising:
a computer usable medium having computer readable program code embodied therein for use with a computer that communicates with equipment on a network using a terminal identification information acquired from a server, the computer readable program code in said program product implementing functions effective to:
halt the communication operation of the computer for reducing the power consumption of the computer;
determine whether said halt communication function of the computer has been initiated; and
send the server a message that the use of the terminal identification information is terminated when it has been determined said halt communication function has been initiated on the computer.

9) The program product according to claim 8, wherein said halt communication function places the computer in a halt communication state wherein power is not supplied to a communication interface portion used for external communication.

10) A program product comprising:
a computer usable medium having computer readable program code embodied therein for use with a computer that communicates with equipment on a network using a terminal identification information acquired from a server, the computer readable program code in said program product implementing functions effective to:
determine whether a communication application program that uses the communication interface controller of the computer is operating; and
send information that the use of the terminal identification information is terminated to the server when it is determined that the communication application program is not operating.

11) A program product comprising:
a computer usable medium having computer readable program code embodied therein for setting a computer in a halt state in which an operating system is halted and wherein the execution state of the operating system is preserved, said computer readable program code being provided for use with a computer that communicates with equipment on a network using a terminal identification information acquired from a server, the computer readable program code implementing functions effective to:
recover from the halt state in response to external directions; and
query the server whether the terminal identification information that was used prior to entering the halt state can be reused for communication with the equipment on a network when the computer has resumed operation from the halt state.

12) The program product according to claim 11, wherein the terminal identification information is an IP address and the server is a DHCP server.

13) The program product according to claim 11, further comprising functions effective to reacquire terminal identification information used for communication with the equipment on a network when it is determined that the terminal identification information used prior to entering the halt state cannot be reused.

14) The program product according to claim 11 further comprising functions effective to determine whether a predetermined time period has lapsed since the terminal identification information was acquired prior to entering the halt state, and to query the server whether the terminal identification information acquired prior to entering the halt state can be reused when it is determined that the predetermined time period has lapsed.

15) A device comprising:
a communication interface controller which controls communication with equipment on a network using terminal identification information acquired from a server;
an operation halt controller, coupled to an operating system, that performs a halting process of terminating the operation of said communication interface controller;
a determination controller, coupled to said operation halt controller, which determines whether the halting process has been initiated by said operation halt controller; and
a sending controller which sends information that the use of the terminal identification information is terminated to the server when it is determined that the halting process has been initiated.

16) The program product according to claim 15, wherein the terminal identification information is an IP address and the server is a DHCP server.

17) A device comprising:
a control command controller for use with a computer that communicates with equipment on a network using a terminal identification acquired from a server, where the control command controller, coupled to an operation halt controller, which sets the computer to a halt state in which an operating system is halted with the execution state of the operating system preserved;
a recovery controller, coupled to said control command controller, which recovers the operating system from the halt state in response to external directions; and
a terminal identification information validation controller, coupled to said recovery controller, which queries the server whether the terminal identification information that was used prior to entering the halt state can be reused for communication with the equipment on the network when the operating system has recovered from the halt state.

18) A method comprising the steps of:
controlling a computer that communicates with equipment on a network using a terminal identification information acquired from a server;
halting computer operation;
determining whether said halting step has been initiated; and
sending information that the use of the terminal identification information is terminated to the server when it is determined that said halting step has been initiated.

19) A method comprising the steps of:
controlling a computer with an operating system wherein the computer communicates with equipment on a network using a terminal identification information acquired from a server;
setting the computer to enter a halt state in which the operating system is halted with the execution state of the operating system preserved;
resuming operation from the halt state in response to external directions; and
querying said server whether the terminal identification information that was used prior to entering the halt state can be reused for communication with the equipment on the network when the computer has resumed operation from the halt state.
